(19) United States
(12) Patent Application Publication
(10) Pub. No.: US 2013/0159382 A1
(43) Pub. Date: Jun. 20, 2013

(54) GENERICALLY PRESENTING VIRTUALIZED DATA

(71) Applicants: Ivan Naranjo Martinez, Redmond, WA (US); Michael John Hillberg, Beaux Arts Village, WA (US)

(72) Inventors: Ivan Naranjo Martinez, Redmond, WA (US); Michael John Hillberg, Beaux Arts Village, WA (US)

(73) Assignee: MICROSOFT CORPORATION, Redmond, WA (US)

(21) Appl. No.: 13/327,706

(22) Filed: Dec. 15, 2011

(51) Int. Cl. G06F 15/16

(52) U.S. Cl. 709/203

(57) ABSTRACT

Embodiments are directed to generically exposing virtualized data stored in the data store and to efficiently providing data from a virtualized data source. In one embodiment, a computer system provides various data interfaces that are configured to receive data requests for data elements stored on a data store. The data store sends an indication that placeholder data is to be displayed while the requested data is retrieved and transmitted. The data store then retrieves the requested data elements according to the received request and dynamically sends the retrieved data elements to the data requestor. The retrieved data elements are then dynamically added to the displayed placeholder data as each data element is received from the data store.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications are designed to present information to users via various user interfaces. These interfaces may be configured to display data in a variety of different manners, depending on how the application's developer has opted to lay out the data. In some cases, an application user may use the user interface to interact with or request data from a remote data source (e.g. from the internet). In such cases, the user interface (e.g. of the browser) would interact with the underlying application to send a data request to the server. The server would receive that request and respond to the application when possible (e.g. after the data request had risen to the top of a processing queue). While the server is processing the data request, the application typically shows the interface as it was pre-request, or shows nothing at all.

### BRIEF SUMMARY

Embodiments described herein are directed to generically exposing virtualized data stored in the data store and to efficiently providing data from a virtualized data source. In one embodiment, a computer system provides various data interfaces that are configured to receive data requests for data elements stored on a data store. The data store sends an indication that placeholder data is to be displayed while the requested data is retrieved and transmitted. The data store then retrieves the requested data elements according to the received request and dynamically sends the retrieved data elements to the data requestor. The retrieved data elements are then dynamically added to the displayed placeholder data as each data element is received from the data store.

In another embodiment, a computer system receives a first data request from a client computer system. The first data request indicates to the data source various data elements that are to be sent to a client computer system user. The computer system then sends the data elements requested in the first data request to the user in response to the first data request. The computer system receives a second data request from the client computer system which indicates to the data source various new data elements that are to be sent to the user. The computer system also sends the data elements requested in the second data request to the user, wherein the data elements automatically update the previously sent data elements as they are received by the at the client computer system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments of the invention may be realized and obtained by means of the instruments and combinations particularly pointed out in the appended claims. Features of the embodiments of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The embodiments of the invention will be described and explained with additional specificity and detail through the use of the accompanying drawings in which:

FIG. 1 illustrates a computer architecture in which embodiments of the present invention may operate including generically exposing virtualized data stored in the data store.

FIG. 2 illustrates a flowchart of an example method for generically exposing virtualized data stored in the data store.

FIG. 3 illustrates a flowchart of an example method for efficiently providing data from a virtualized data source.

FIGS. 4A and 4B illustrate embodiments in which data elements are loaded in a classic and in an incremental manner, respectively.

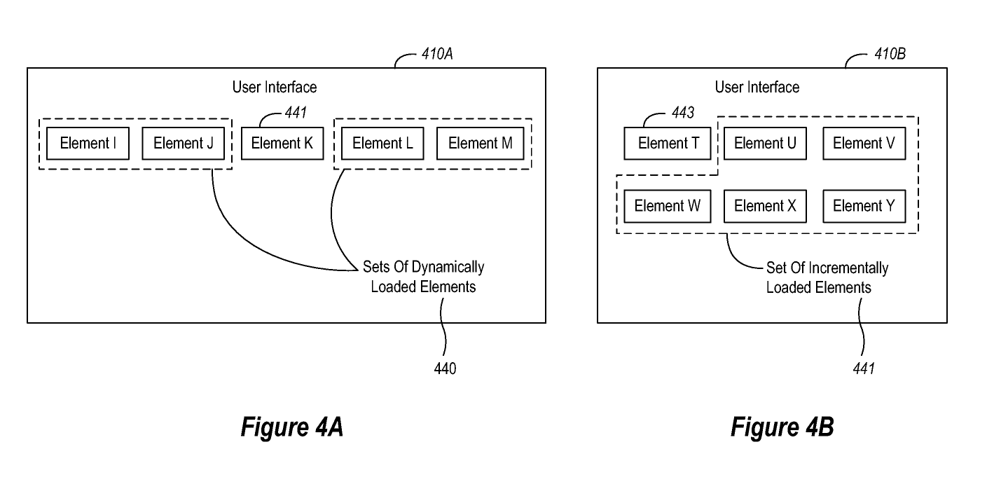

### DETAILED DESCRIPTION

Embodiments described herein are directed to generically exposing virtualized data stored in the data store and to efficiently providing data from a virtualized data source. In one embodiment, a computer system provides various data interfaces that are configured to receive data requests for data elements stored on a data store. The data store sends an indication that placeholder data is to be displayed while the requested data is retrieved and transmitted. The data store then retrieves the requested data elements according to the received request and dynamically sends the retrieved data elements to the data requestor. The retrieved data elements are then dynamically added to the displayed placeholder data as each data element is received from the data store.

In another embodiment, a computer system receives a first data request from a client computer system. The first data request indicates to the data source various data elements that are to be sent to a client computer system user. The computer system then sends the data elements requested in the first data request to the user in response to the first data request. The computer system receives a second data request from the client computer system which indicates to the data source various new data elements that are to be sent to the user. The computer system also sends the data elements requested in the second data request to the user, wherein the data elements automatically update the previously sent data elements as they are received by the at the client computer system.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmissions media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

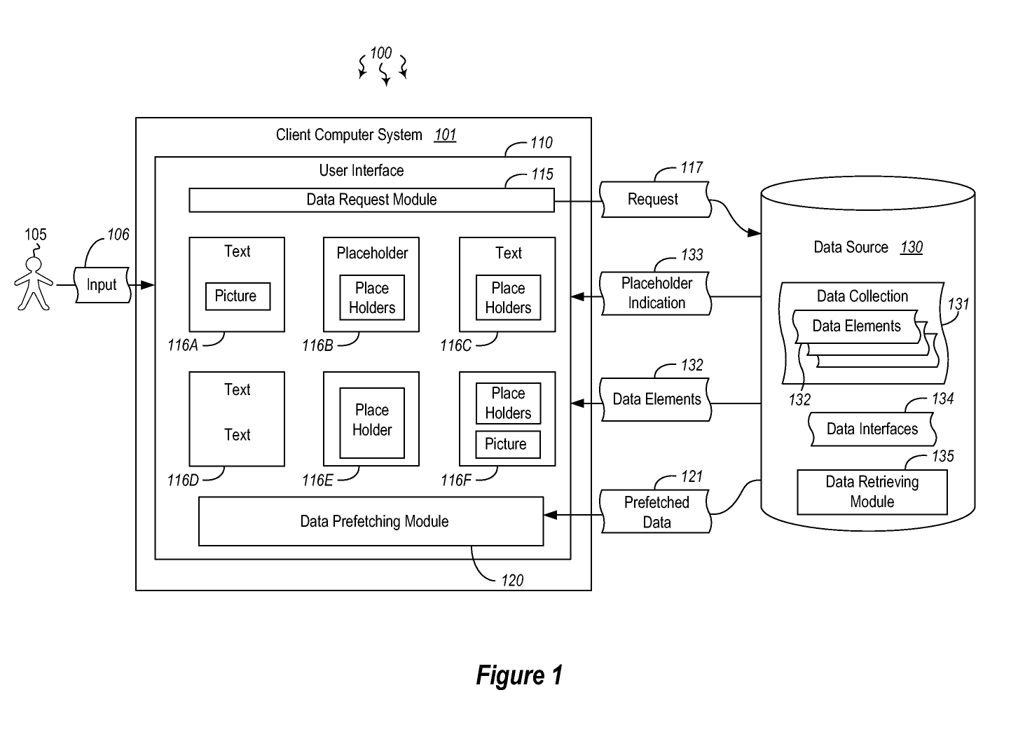

FIG. 1 illustrates a computer architecture 100 in which the principles of the present invention may be employed. Computer architecture 100 includes client computer system 101. The client computer system be any type of local or distributed computer system, including a cloud computing system. The client computer system may be configured to run various different software applications. Each of these applications may have its own user interface 110. The user interface (UI) may be an interface for any type of software application, and may receive various different types of user inputs including mouse, keyboard, touchscreen and other inputs. The UI may be configured to interact with a data source 130 (alternatively data store 130 herein). The data source may store the data, or may simply act as a proxy that forwards data requests 117 on to the actual location where the data is stored. The data source 130 may include multiple different data collections 131, each of which includes data elements 132. These data elements may be virtualized on the data source, and may be sent to the UI in any order. The data source includes various different data interfaces 134 that allow data to be requested, retrieved and sent to the client computer system as it becomes available, in any order.

In some embodiments, a “classic” mode of data virtualization may be used, where the data in the collection appears if the entire data collection is loaded. The interfaces then retrieve more data as it is requested by the user (e.g. as the user navigates through data elements of the UI). In some cases, additional data in the data collection may be prefetched so it will be ready if the user wants to access it (e.g. by navigating to it). In another example, an “incremental” mode of data virtualization may be used, where the collection data is incrementally grown by fixed size increments as a user approaches the end of the collection (either at the very end or a certain number of pages from the end).

Classic data virtualization, as described herein, allows the data source 130 to return a placeholder value while the actual data is retrieved (e.g. by starting an asynchronous request to fetch the data). The client computer system will display placeholder data in the UI for the data item while the actual data is retrieved from the data source. In this manner, the collection appears to be fully present (or fully downloaded) even though only a portion of the data has been loaded. Optionally, a prefetching interface may be implemented which requests a block of items that aren't being displayed but will likely be displayed in the near future.

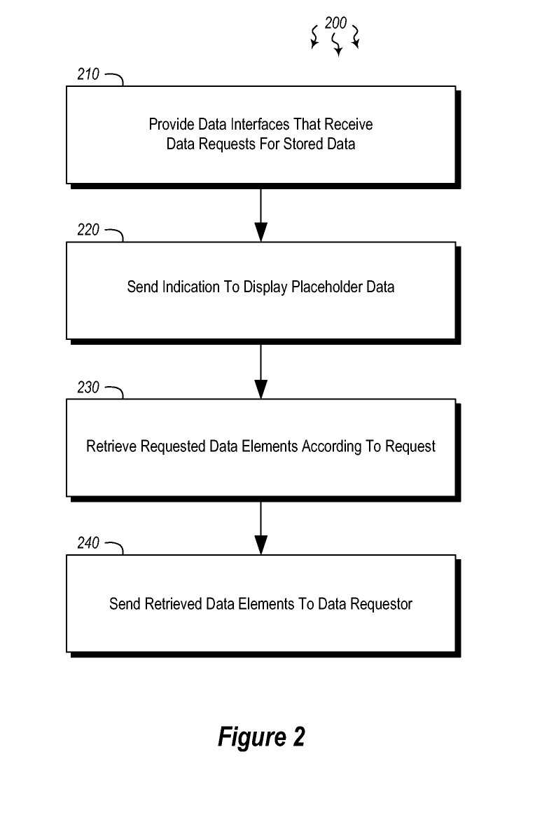

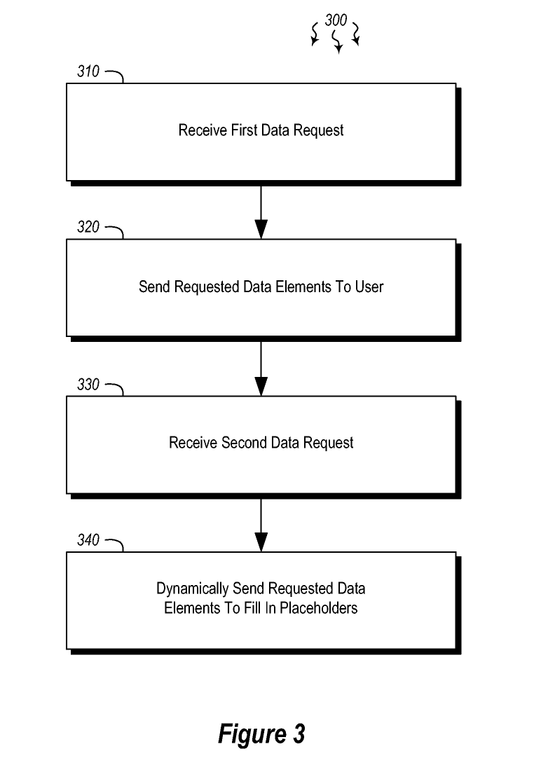

Incremental data virtualization loads a predetermined amount of data and then retrieves subsequent blocks of data items as needed. When using incremental data virtualization, the client computer system will listen for customizable triggers (e.g. at the end of the collection, N pages from the end of the collection, or when manually invoked) and trigger the request for the next set of data items. Optionally, placeholder data may be shown in the UI for the items as they are being requested. In some cases, the data source 130 may support both types of data virtualization at the same time (e.g. a search data source that allows users to browse all (or substantially all) resulting search results in one big list, or allows them to get the pages one page at a time). In such cases, the client computer system will determine which mode to use (or both modes when desired). These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for generically exposing virtualized data stored in the data store. The method 200 will now be described with frequent reference to the components and data of environment 100.

Method 200 includes an act of providing one or more data interfaces that are configured to receive data requests for one or more data elements stored on the data store (act 210). For example, data request module 115 of UI 110 may send request 117 for various data elements 132 of data collection 131. The data elements may be any type of text, picture, video or other type of data. These data elements are stored in data source 130. The data source may be local or remote, and may be a single or a distributed storage solution (e.g. a storage area network (SAN)). The request 117 may be sent as a result of receiving input 106 from user 105, where the input indicates that the user desires to view data elements in the collection. The data source includes different data interfaces 134 that facilitate receiving the data requests, retrieving the requested data, and providing the data to the client computer system in an efficient manner. At least in some cases, the interfaces may receive the data requests and forward them to a separate data store. Then, when the data is retrieved from the data store, the interfaces send the retrieved data to the client computer system.

Next, method 200 includes an act of the data store sending an indication that placeholder data is to be displayed while the requested data is retrieved and transmitted (act 220). For example, data source 130 may send placeholder indication 133 to the UI of client computer system 101. The placeholder indication may be any type of data, code, function, signal or other indicator that placeholder data is to be displayed while the requested data is retrieved. The placeholder itself may take on different shapes and forms depending on what the UI maker/user determines. For instance, if the data elements are movies in a movie collection, the placeholders may be grey boxes or movie box outlines or some other image or portion of text that indicates that the actual data is yet to come.

Next, method 200 includes an act of retrieving the requested data elements according to the received request (act 230). Data retrieving module 135 may retrieve each of the requested data elements simultaneously, sequentially or in any different order. The user interface 110 may display placeholder data for each of the six data elements shown in the UI (as will be understood, substantially any number of data elements may be displayed in the UI). Thus, as shown in element 116B, placeholders may be shown in place of text and/or an image. As the data is received from the data source 130, the data may be automatically filled in where the placeholder was. Thus, as shown in element 116A, the picture and text have been received and are being displayed. Similarly, in element 116D, two portions of text have been received. In element 116E, no data element has been received, so only a placeholder is shown. In element 116F, a picture has been received on the bottom, but the picture on the top has not been received. Element 116C shows a situation where text has been received, but the picture below it has not been received. While pictures and text are used in FIG. 1, it should be noted that any type of data element may be displayed and used in UI 110.

Method 200 further includes an act of dynamically sending the requested retrieved data elements to the data requestor, wherein the retrieved data elements are dynamically added to the displayed placeholder data as each data element is received from the data store (act 240). As data elements 132 are received from the data store 130, they can be dynamically added or “popped-in” as they are received (and, at least in some cases, in the order they are received). The UI (or client computer system 101) may determine that no data requests have been received for a specified amount of time, indicating that the user interaction with the data elements has at least temporarily stopped.

Once it has been determined that the user is viewing the elements (or at least isn't navigating to new elements), data prefetching module 120 may prefetch subsequent data elements at the data source 130. The data source may then send the prefetched data elements to the user or data requestor. Thus, in cases where a collection includes many hundreds, thousands or millions of documents, and the first six are displayed on UI 110, the data prefetching module may prefetch elements seven through ten, for example. The number of prefetched elements 121 may be customizable per user, per computer system, per application or per some other defined policy.

While the user is viewing the requested data elements, the data store may receive a data request from the data requestor (i.e. user 105) within a predetermined time, indicating that the data requestor has interacted with one or more of the data elements. The interaction may indicate that new data elements are to be loaded and displayed. As a result, any data prefetching that is not yet complete may be cancelled, and the new data elements may be requested from the data source 130. In some cases, data prefetching may be automatically initiated when the data elements of a given data collection are N pages from the end of the collection (where “N” is a customizable variable). Data prefetching may also be automatically initiated when the last data elements of a given data collection have been sent to the user. Thus, if a user has browsed to the end of the data collection, data at the beginning of the collection may be prefetched, in anticipation that the user will return to the beginning. The data may also be prefetched when an initiation indication is received from the user, indicating that certain data elements are to be displayed, while other elements are prefetched. In this manner, prefetched data may be used to enhance the user's data element browsing experience.

FIG. 3 illustrates a flowchart of a method 300 for efficiently providing data from a virtualized data source. The method 300 will now be described with frequent reference to the components and data of environment 100.

Method 300 includes an act of receiving a first data request from a client computer system, the first data request indicating to the data source various data elements that are to be sent to a client computer system user (act 310). For instance, if the data collection is a collection of cooking recipes, the user may be navigating between the different recipe pictures and accompanying text. In some cases, the recipes may include videos or other web content. The elements requested in the first data request are sent to the user in response to the first data request (act 320).

As mentioned above, the data may be requested and received at different times (i.e. asynchronously). Consequently, the data source 130 may send a placeholder indication 133 to the user's computer system, indicating to the user's computer system that it is to display placeholder data for each of the requested elements. Then, as the data elements are received from the data source, they can be automatically and dynamically added to the UI. Thus, data elements 116A-116F show different stages of receiving data. In element 116A, both text and picture data have been received and are displayed. In element 116B, neither text nor picture have been received and, as a result, placeholder data is displayed for each. In the other elements shown, either none, some or all of the data elements have been received. As the user scrolls or otherwise navigates (e.g. via a hyperlink) to other data elements in the collection, placeholder data for these new elements may be displayed as their corresponding data is retrieved. In this manner, the collection of data elements appears to be fully loaded on the user-navigable interface, while in fact, only a portion of the collection has been transmitted from the data source.

Method 300 further includes an act of receiving a second data request from the client computer system, the second data request indicating to the data source one or more new data elements that are to be sent to the user (act 330). Thus, data source 130 may receive a second data request 117 from the client computer system indicating that new, different data elements from the collection 131 are to be sent to the user for display by UI 110. In some cases, if the initially returned data elements are hyperlinks from a web search, and the second data request indicates that additional results are to be shown, the additional data elements may be retrieved and sent to the user as they are fetched from the data collection. The data source may send placeholder indications 133 for the new data elements, and begin transmitting the newly requested data.

The UI may also request that one or more additional data items be prefetched. The prefetching may be automatic, it may be automatic once certain triggers are met, or it may be performed when manually requested. The client computer system 101 may determine which data elements or pages are most likely to be subsequently viewed by the user. Those pages may be prefetched while the user is viewing and/or interacting with the currently displayed elements. The prefetch triggers may be user-customizable, at least in some embodiments, and may include any one or more of the following: reaching N pages from the end of the data collection (where “N” is a variable number), reaching the end of the data collection and receiving a manual user indication that data is to be prefetched.

Thus, continuing the example above, the client computer system may send the data elements requested in the second data request to the user. The data elements automatically update the previously sent data elements as they are received at the client computer system (act 350). The data store may determine that the second data request has requested data elements that trigger a request for a subsequent set of data elements to be retrieved at the data store. The retrieving module 135 may then retrieve the subsequent set of data elements triggered by the second data request and dynamically send the subsequent set of data elements to the client computer system. In this manner, the client computer system is updated with the subsequent set of data elements as each data element is received from the data source.

Accordingly, as shown in FIG. 5A, if a user is viewing element K (541) in UI 510A, elements I, J, L and M (540) may be dynamically loaded around element K. Thus, as a user browses, data elements are continually loaded around the currently-viewed element. Moreover, as shown in FIG. 5B, if a user has navigated to element T (543), the user interface 510B may display element T, along with other incrementally loaded elements (i.e. elements U, V, W, X and Y (541)). If the data for each data element has not yet been entirely received, placeholder data may be displayed for each element (or each portion of data within the data element).

Still further, in FIG. 5B, element T may be within 10 pages of the end of the collection (assuming that the collection ends in element Z). If the variable “N” was 10, and a trigger was set for updating at 10 pages from the end, then the trigger would be met and the next (configurable) number of incrementally loaded elements would be loaded. These elements may then be dynamically updated on the UI 510B, as each data element is received from the data source. In this manner, data elements are incrementally and dynamically loaded as the user browses or interacts with a data collection.

Accordingly, methods, systems and computer program products are provided which generically expose virtualized data stored in the data store. Moreover, methods, systems and computer program products are provided which efficiently provide data from a virtualized data source to a user through a user interface.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a data store computer system including at least one processor and a memory, in a computer networking environment including a plurality of computing systems, a computer-implemented method for generically exposing virtualized data stored in the data store, the method comprising:
an act of providing one or more data interfaces that are configured to receive data requests for data elements stored on the data store;
an act of the data store sending an indication that placeholder data is to be displayed while the requested data is retrieved and transmitted;
an act of retrieving the requested data elements according to the received request; and
an act of dynamically sending the retrieved data elements to the data requestor, wherein the retrieved data elements are dynamically added to the displayed placeholder data as each data element is received from the data store.

2. The method of claim 1, wherein the placeholder data comprises a predefined portion of data that represents a corresponding data element.

3. The method of claim 1, wherein the data elements are dynamically added in the order they are received.

4. The method of claim 1, further comprising:
an act of determining that no data requests have been received for a specified amount of time, indicating that user interaction with the data elements has at least temporarily stopped;
an act of prefetching one or more subsequent data elements at the data source; and
an act of sending the prefetched data elements to the data requestor.

5. The method of claim 4, further comprising:
an act of receiving a data request from the data requestor within a predetermined time, indicating that the data requestor has interacted with one or more of the data elements; and
an act of cancelling the data prefetching.

6. The method of claim 4, wherein the number of pages to prefetch is customizable by the data requestor.

7. The method of claim 1, wherein data prefetching is automatically initiated when the data elements of a given data collection are n pages from the end of the collection.

8. The method of claim 1, wherein data prefetching is automatically initiated when the last data elements of a given data collection have been sent to the data requestor.

9. The method of claim 1, wherein data prefetching is initiated upon receiving an initiation indication from the data requestor.

10. A computer program product for implementing a method for efficiently providing data from a virtualized data source, the computer program product comprising one or more computer-readable storage media having stored thereon computer-executable instructions that, when executed by one or more processors of the computing system, cause the computing system to perform the method, the method comprising:
an act of receiving a first data request from a client computer system, the first data request indicating to the data source one or more data elements that are to be sent to a client computer system user;
an act of sending the data elements requested in the first data request to the user in response to the first data request;
an act of receiving a second data request from the client computer system, the second data request indicating to the data source one or more new data elements that are to be sent to the user; and
an act of sending the data elements requested in the second data request to the user, wherein the data elements automatically update the previously sent data elements as they are received at the client computer system.

11. The computer program product of claim 10, further comprising prefetching one or more data elements based on one or more prefetch triggers.

12. The computer program product of claim 11, wherein those pages determined most likely to be subsequently viewed by the user are prefetched upon the occurrence of at least one of the prefetch triggers.

13. The computer program product of claim 11, wherein the prefetch triggers comprise at least one of the following: reaching n pages from the end of the data collection, reaching the end of the data collection and receiving a manual user indication that data is to be prefetched.

14. The computer program product of claim 10, wherein placeholder data is displayed at the client computer system for one or more data elements until those data elements are received from the data source.

15. The computer program product of claim 10, wherein the collection of data elements appears to be fully loaded on the user's computer system.

16. The computer program product of claim 10, further comprising:
an act of determining that the second data request has requested data elements that trigger a request for a subsequent set of data elements to be retrieved at the data source;
an act of retrieving the subsequent set of data elements triggered by the second data request; and
an act of dynamically sending the subsequent set of data elements to the client computer system, such that the client computer system is updated with the subsequent set of data elements as each data element is received from the data source.

17. The computer program product of claim 16, wherein placeholder data is displayed at the client computer system for each requested subsequent set of data elements until the sets' corresponding data is received from the data source.

18. A computer system comprising the following:
one or more processors;
system memory;
one or more computer-readable storage media having stored thereon computer-executable instructions that, when executed by the one or more processors, causes the computing system to perform a method for efficiently providing data from a virtualized data source, the method comprising the following:
an act of receiving a data request from a user, the data request indicating to the data source one or more data elements that are to be sent to the user;
an act of sending the data elements requested in the data request to the user in response to the data request;
an act of determining that the data request has requested data elements that trigger a request for a subsequent set of data elements to be retrieved at the data source;
an act of retrieving the subsequent set of data elements triggered by the data request; and
an act of dynamically sending the subsequent set of data elements to the user, such that the user's computer system is updated with the subsequent set of data elements as each data element is received from the data source.

19. The computer system of claim 18, wherein placeholder data is displayed on the user's computer system for each of the requested data elements in the subsequent set of data elements.

20. The computer system of claim 18, wherein those pages determined most likely to be subsequently viewed by the user are prefetched upon the occurrence of at least one prefetch trigger, the prefetch trigger comprising at least one of the following: reaching n pages from the end of the data collection, reaching the end of the data collection and receiving a manual user indication that data is to be prefetched.
